(19) United States
(12) Patent Application Publication
(10) Pub. No.: US 2014/0218302 A1
(43) Pub. Date: Aug. 7, 2014

(54) TOUCH AND TAP OPERABLE WORK SURFACE

(71) Applicant: MiSeat, Inc., Chicago, IL (US)

(72) Inventor: Ron Carlson, Hawthorn Woods, IL (US)

(73) Assignee: MiSeat, Inc., Chicago, IL (US)

(21) Appl. No.: 14/168,191

(22) Filed: Jan. 30, 2014

Related U.S. Application Data
(60) Provisional application No. 61/840,627, filed on Jun. 28, 2013.
(60) Provisional application No. 61/810,556, filed on Apr. 10, 2013.
(60) Provisional application No. 61/789,095, filed on Mar. 15, 2013.
(60) Provisional application No. 61/759,729, filed on Feb. 1, 2013.

(51) Int. Cl. G06F 3/01; G06F 3/02; G06F 3/041

(52) U.S. Cl. CPC G06F 3/01; G06F 3/041; G06F 3/0202
USPC 345/168; 345/173; 29/825

(57) ABSTRACT

A work surface is configured to provide user interaction with a computer. The work surface includes a substrate that provides a structural base for the work surface. The work surface also includes one or more input devices installed on the substrate. The input devices can be operable to detect a user touch and/or tap, and to generate a signal based on the touch/tap. The work surface also includes a protector film covering the at least one input device. An adhesive material, such as a double-sided adhesive tape, attaches the protector film and the input devices in a manner that allows the input devices to detect a user touch through the protector film and the adhesive material.

### RELATED APPLICATIONS

This application claims priority to the following U.S. Provisional patent applications, each of which is titled “Workstation With Touchscreen Interface”: No. 61/759,729, filed on Feb. 1, 2013, No. 61/789,095, filed on Mar. 15, 2013, No. 61/810,556, filed on Apr. 10, 2013, and No. 61/840,627, filed on Jun. 28, 2013. Each of U.S. Provisional Patent Application Nos. 61/759,729, 61/789,095, 61/810,556, and 61/840,627 is hereby incorporated by reference in its entirety.

### BACKGROUND

Touch technology can be applied to operate a wide variety of electronic devices. For example, touch technology can be applied to operate cell phones, tablet devices, computers, appliances, watches, as well as several other types of equipment. Touch technology, however, can be quite sensitive to the effects of an external environment.

For example, fluids and moisture that penetrate a touch device can impact the ability of the touch technology to operate. Fluids and moisture can seep into the underlying electronic equipment, damaging or even ruining the equipment. Touch technology also often involves the use of glass or other brittle materials as a touch surface. As a result, these touch surfaces can crack, shatter, or scratch relatively easily when subject to regular use if not properly protected.

Touch technology employed in public environments is subject to even more frequent threats of spills, impacts, and abrasions. This is particularly so in environments that have a high user turnover, or in environments where there is a presence of food, beverages, soiled materials, or heavy equipment. For example, touch technology employed in restaurants, coffee shops, factories, fitness centers, and outdoor locations are often exposed to high levels of fluids, soil, impacts, and abrasions. It can be difficult, therefore, to apply the touch technology in these public locations, particularly where the users are repeatedly placing plates, silverware, beverages, keys, bags, tools, towels, or other objects that can threaten the touch functionality on the work surface.

### SUMMARY

The present technology provides a work surface configured to provide user interaction with a computer. In some embodiments, the work surface includes a substrate that provides a structural base for the work surface. The substrate can have an upper surface, and can include one or more input devices installed on the substrate. The input device(s) can be operable to receive input from a user and to generate a signal based on the input. In some aspects of the present technology, the work surface also includes a protector film covering the input device(s). In certain embodiments, an adhesive material adheres the protector film to the input device(s) and/or the substrate. The input device can be configured to detect a touch and/or a tap of a user through the protector film and the adhesive material.

Certain embodiments provide a method of making a work surface configured to provide user interaction with a computer. The method includes the step of providing a substrate as a structural support for the work surface. In some aspects, the method generates one or more routed portions in the substrate, where each routed portion is configured to receive one or more input devices. The method can also include the step of installing one or more input device in the routed portion(s) of the substrate. In some embodiments, the method includes the step of applying an adhesive material to the substrate and the input device(s). The method can also involve applying a protector film over the substrate and the input device(s) by securing the protector film to the adhesive material. In some aspects, the method also involves removing any air pockets that exist between the substrate or the input devices and the protector film.

Some embodiments of the present technology provide a work surface configured to provide user interaction with a computer. The work surface can include a substrate configured to provide a structural base for the work surface. The substrate can have an upper surface, which can include a one or more routed portions. In some embodiments, the work surface comprises a sensing pad installed one routed portion of the substrate. The sensing pad can be operable to detect a user's touch, and to track the motion of a user's finger along the sensing pad. In some embodiments, the work surface comprises a keypad installed in another routed portion of the substrate. The keypad can have a plurality of tap keys, each tap key configured to generate a signal when tapped by a user. In some embodiments, the work surface also includes a protector film that covers the substrate, the sensing pad and the keypad. An adhesive material can adhere the protector film to the sensing pad and the keypad. The sensing pad can be configured to detect the touch of a user through the protector film and the adhesive material. Likewise, the keypad can be configured so that each key of the keypad is operable to detect a user tap through the protector film and the adhesive material. In some embodiments, the work surface is configured to communicate with at least one computer, and the sensing pad and the keypad are operable to provide input to the computer.

### BRIEF DESCRIPTION OF THE DRAWINGS

FIG. 1 is an isometric view of a workstation employing a work surface in accordance with at least one embodiment of the present technology.

FIG. 2 is a top view of a workstation employing a work surface in accordance with at least one embodiment of the present technology.

FIG. 3 is a top view of a workstation employing a work surface in accordance with at least one embodiment of the present technology.

FIG. 4 shows a portion of a work surface with a protector film slightly peeled back in accordance with at least one embodiment of the present technology.

FIG. 5 is a side view of a work station showing the depth of a routed portion of a work surface substrate in accordance with at least one embodiment of the present technology.

FIG. 6 shows an adhesive material application pattern as it is applied to a work surface in accordance with at least one embodiment of the present technology.

FIG. 7 is a flow diagram detailing the steps of a method in accordance with at least one embodiment of the present technology.

### DETAILED DESCRIPTION

The present technology relates to touch and/or tap operated electronic equipment. More specifically, the present technology relates to a touch and/or tap operated work surface that provides user interaction with a computer.

Touch operated devices (which, as used in this specification, can include tap operated devices and touch/tap operated devices) typically employ an interface surface that is hard and inflexible. For example, touch operated devices often use glass or a hard plastic as an interface surface. In such a device, the user can touch or tap the rigid surface and transmit electronic signals to the electronic equipment that lies beneath the surface to operate electronic functionality.

Rigid, inflexible touch surfaces, however, can present problems with the operations of the device and equipment. For example, if not properly protected, hard surfaces can be subject to scratches and abrasions, which can negatively impact the viewability of the displays beneath the surface. This is particularly so with workstations designed for use in public areas that have many users that place their belongings on the work surface.

Moreover, hard and inflexible touch surfaces can crack, break or fracture when impacted, if not properly protected. Cracks and fractures can negatively impact the visibility of the work surface, and it can also limit or even ruin the touch functionality of the device. Cracks and fractures can be common in situations where users are frequently placing hard and/or heavy objects such as plates, glasses, silverware, tools, keys, or bags on the surface. Further, cracks and fractures allow fluids to penetrate the surface, which can damage or ruin the electronic equipment that lies beneath. This can be a particular concern in environments where food and fluids are commonly placed upon the working surface, such as bars, restaurants, and coffee shops.

Hard, inflexible touch surfaces can be difficult to print upon because they cannot be rolled or passed through standard printing devices. For example, a glass work surface may be unable to have an image or graphic printed upon it without requiring the use of special glass printing machines operated and handled with extreme care and caution. Conversely, printing on flexible materials can be more efficient and cost effective, because these products can be rolled and folded. And because flexible materials are not fragile or breakable like glass, the do not require extreme care and caution when handling and storing.

Hard, inflexible touch surfaces also present problems by way of accuracy and efficiency in the touch or tap operated devices. For example, hard and inflexible covering surfaces may not be able to flex or mold to conform to the shape of the electronic equipment the surfaces are designed to cover. In this manner, air gaps or spacing can occur between the hard surface and the touch operated equipment. This spacing can reduce the touch sensitivity of the device, thereby limiting the efficiency of the device. Moreover, tap oriented devices that rely on the detection of a vibration and/or force generated by a physical tap (as opposed to the detection of a capacitive touch alone) may not operate effectively when installed beneath inflexible surfaces because the inflexible surface may distribute the face of the tap over a wide area, rather than to the particular key or location that the user intended to tap.

The present technology provides a new work surface that allows a user to execute various touch and tap operated electronic controls and equipment in an effective and efficient manner. The present technology uses a flexible protector film that can be used to cover and protect the electronic equipment of the work surface while still allowing for functional touch and tap operability.

The present technology applies the protector film to the work surface using an adhesive material, such as double-sided adhesive tape, which allows the touch and tap functionality of the work surface to operate through the protector film. The double-sided adhesive tape provides a flat and even adhesion surface, which allows for a reduction in the air bubbles formed between the touch-operated equipment and the protector film. In this manner, the present technology provides a work surface that is more effective and sensitive to the touch.

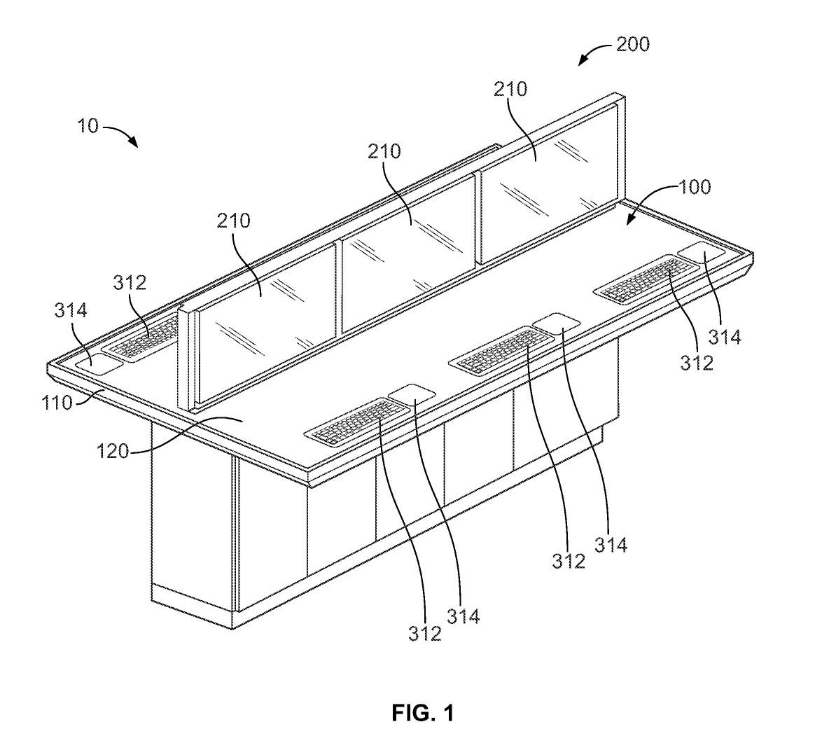

FIG. 1 provides an example of a workstation 10 employing a touch-operable work surface 100 of the present technology. FIG. 1 shows an isometric view of a countertop workstation 10 that can be used, for example, in a restaurant or coffee shop. As shown in FIG. 1, the countertop workstation 10 has a front area 20 comprising three separate work areas, and a rear area 30 opposite the front area 20, also having three separate work areas.

The countertop workstation 10 also has a viewing area 200, which comprises six separate viewing stations 210, each viewing station 210 having monitors providing an electronic display to each work area. Each work area has a keypad area 312, which can be used as a touch or tap operated keyboard, for example. Each work area also has a touch-operable sensing pad area 314, which can be a tracking pad, or mouse pad, for example. In this manner, a user of a particular work area can operate and interact with one or more computers via the keypad area 312 and the sensing pad area 314.

In some embodiments, the workstation 10 includes one or more computers or processor units (“CPU's”) that can be accessed, managed, and/or operated via the keypad area 312 and sensing pad area 314. The CPU's can generate output on the viewing area 200 of the workstation in the same manner that a computer generates output on a local monitor. In some embodiments, the CPU can be connected to a network or to the internet, either wirelessly, or via a wired connection, for example.

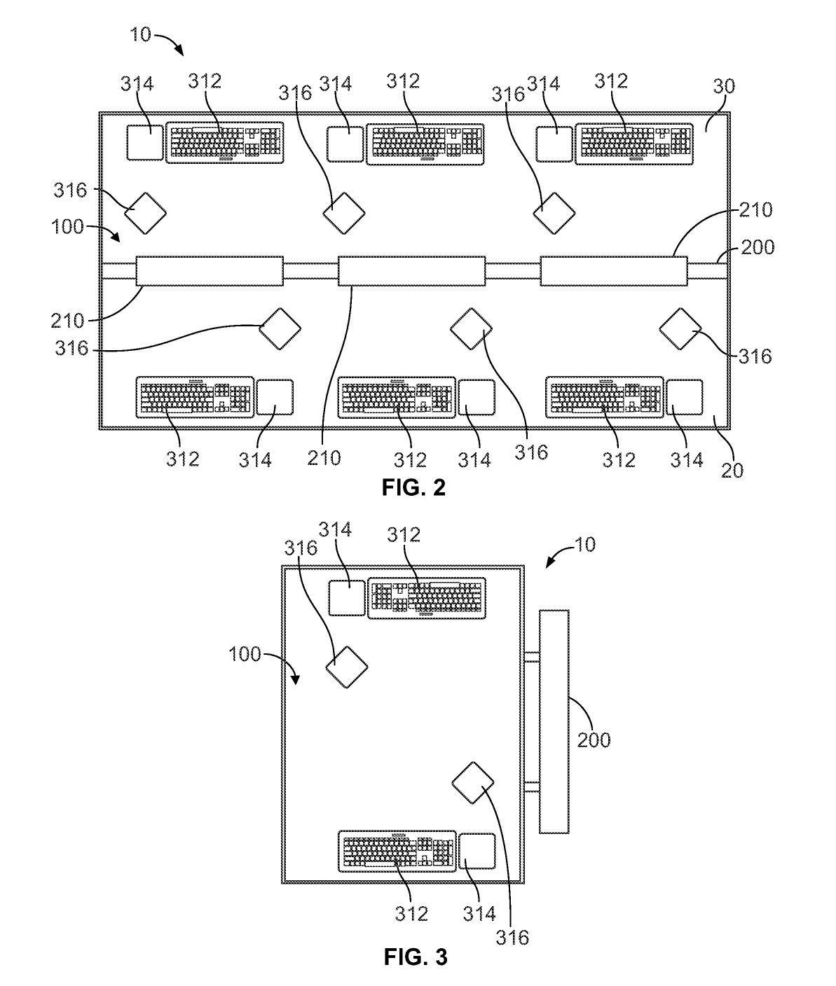

FIG. 2 provides an overhead view of another exemplary embodiment of a countertop workstation 10 having six work areas. As shown in FIG. 2, each work area can also comprise an induction charger 316, which can be used, for example, to charge a user's smart phone or mobile device. For example, the induction charging station 316 can be embedded in the substrate 110 of the work station and covered by the protector film 120, which can be adhered to the induction charging station 316, for example, with an adhesive material, such as a double-sided adhesive tape. In this manner, a user can place a mobile device equipped with induction charging equipment on the induction charger 316 surface, thereby allowing the battery of the mobile device to receive an electric charge while the user operates the workstation equipment.

In some embodiments, the workstation 10 can also be equipped with a near field communications reader (“NFC reader”) that allows the computer of the workstation 10 to communicate with a user's mobile device. In this manner, the present technology can be capable of logging a user into the workstation 10, the computer, or another network by swiping, scanning and/or reading a user's mobile device, such as a cell phone or smart phone, for example. The NFC reader can also provide a user of the workstation 10 with access to certain information or accounts, for example, via the internet or the cloud.

FIG. 3 shows an example embodiment of another workstation 10 employing a work surface 100 of the present technology in another configuration. The workstation 10 of FIG. 3 has two work areas facing one another, each work area having a keypad 312, a sensing pad 314, and an induction charging station 316. The workstation 10 also has a viewing area 200 at an edge of the work surface 100 so that each work area can view the viewing area 200 at an angle of 90 degrees.

Workstations employing the work surface 100 of the present technology can take on various embodiments and configurations. For example, the workstations can be countertop stations designed for use as countertops, tables, bar, and kiosks, in dining and/or drinking establishments, libraries, classrooms, museums, or airports, for example.

In some embodiments, the workstations can be designed for use in an office environment, such as a personal desk station for an employee in an office. In some embodiments, the workstations can be vertical workstations, for example, stations mounted on a wall. Such vertical workstations may be used, by way of example, in a classroom setting, in a museum, or at a public information kiosk. Various embodiments and configurations of workstations capable of using the work surface 100 of the present technology are described in the disclosures and depicted in the Figures of U.S. Provisional Patent Application Nos. 61/759,729, 61/789,095, 61/810,556, 61/840,627, each of which is hereby incorporated by reference its entirety. Additional configurations of workstations suitable for use with the present technology can be seen in U.S. Design patent application Nos. 29/459,379, titled “Desktop Workstation,” and 29/459,386, titled “Countertop Workstation,” each of which is incorporated by reference its entirety.

As shown in FIGS. 1-3, the work surface 100 comprises a substrate 110, which can be used as a structural base for the work surface 100. The substrate 110 can have an upper surface that is relatively flat or planar, with certain portions routed out for installation of various work surface equipment. For example, the keypads 312 and the sensing pads 314 shown in FIGS. 1-3 can be installed in routed out portions of the substrate 110 so that the upper surfaces of the keypads 312 and sensing pads 314 are generally flush, level, or even with the upper surface of the substrate 110. The substrate 110 and the other equipment is covered by a flexible protector film 120, which, as described herein, can be attached to the substrate 110 and the other electronic equipment with an adhesive material.

The substrate 110 can be made of a number of materials. For example, in some embodiments, the substrate 110 can be made of wood, such as a laminated pressed wood or particle board. In some embodiments, the substrate 110 can be made of other materials such as a composite, a laminate, a plastic, a metal, or a stone, for example. The substrate 110 can vary in thickness, but should be thick enough to allow for the electronic equipment to be embedded therein while still having an upper surface that is generally flush, level, or even with the upper surface of the installed equipment. For example, in some embodiments, the substrate 110 can be 1 and ⅛ of an inch thick.

The substrate 110 can be drilled with holes so that the cables, cords, and/or wires used to connect and/or supply power to the CPU and the electronic equipment embedded within the work surface 100 can be routed below the work surface 100. For example, cables for keypads, sensing pads, and/or the viewing stations can be routed through holes in the substrate 110 and over to a power center, a CPU and/or another device.

In some embodiments, the holes can be sealed to prevent heat and air from coming through the holes, which can cause the protector film 210 to bubble, warp, wrinkle, stretch, or otherwise cause air pockets to form beneath the protector film 120, which can result in undesirable effects of the work surface 100. For example, in some embodiments, the holes can be sealed with caulk, silicone, or another substance to limit and/or prevent heat from entering the area between the substrate 110 and the protector film 120. In some embodiments, a cooling fan can be mounted to the underside of the substrate 110 to help cool the work surface 100 and prevent heat from rising to undesirable levels.

The substrate 110 and the other electronic equipment of the work surface 100 can be covered and/or protected with a flexible protector film 120. The protector film 120 can be a flexible material that is attachable to the work surface 100 and used to protect the equipment that lies underneath, while still allowing a user to operate the touch and/or tap functionality of the underlying equipment. In some embodiments, the protector film 120 is flexible and durable so to resist tears and abrasion, while allowing also user taps and touches to be transmitted to underlying tap and touch sensitive equipment.

In certain embodiments, the protector film 120 can be optically clear. Additionally and/or alternatively, the protector film 120 can be transparent, translucent or opaque. In further embodiments, the protector film 120 is printable—that is, it can have a printable substance (e.g., ink, toner, paint, etc.) printed on one or more surfaces of the film. For example, the printable substance can be printed on an upper or lower surface of the protector film.

The protector film 120 can be back painted or provided with other scanned or printed pictorial, and can be printed to display a color scheme or media finish. For example, in some embodiments, the protector film 120 is can have one or more photo realistic image or another graphic printed upon a surface of the film. In certain embodiments, the printed protector film 120 can be placed on top of equipment, and then printed with an image or graphic helping a user identify the location or functionality of the underlying equipment. For example, the work surface 100 can have an image of a “QWERTY” keyboard printed on the protector film 120 to help a user identify the specific key locations of a keypad beneath the protector film. In this manner, the protector film 120 and the underlying touch and/or tap equipment can operate together to control the display of the work surface.

In certain embodiments, the protector film 120 can be provided with a textured surface to assist a user in distinguishing the various portions of the work surface 100, which may operate various functionality. For example, for a portion of the work surface 100 that operates as a sensing pad (i.e., a mouse pad), a textured portion can be sandblasted to create a rough surface, thereby helping a user identify the location and borders of the pad. Certain embodiments may employ the use of bumps, ridges, raised portions, indentations, milled-out sections or other features that distinguish the various locations of the work surface 100. For example, certain embodiments may employ ridges to define the shape for of each key of a touch or tap keypad or keyboard. In some embodiments, bumps, raised portions, indentions, milled out sections, or other tactile features can be implemented to represent the location of certain keys of a keypad and/or keyboard. For example, a protector film may employ indentations or raised portions over the “F,” “J,” and/or number “5” keys on a keyboard to assist a user in finding a proper hand position for typing.

The protector film 120 can be flexible so that it can be adhered to the substrate 110 and other equipment of the work surface 100 without resulting in substantial bubbles forming beneath the protector film 120. This flexibility also provides an advantage over other surfaces because it allows underlying touch and/or tap sensitive equipment to maintain higher levels of sensitivity and accuracy. For example, tap sensitive devices that respond to user taps—i.e., physical vibrations and/or forces generated by user fingers executing a typing motion—can accurately detect the user's tapping because the flexible nature of the protector film 120 allows the force of the tap to be directly transmitted to the proper keys lying beneath the film.

In some embodiments, the protector film 120 is water resistant, waterproof, or otherwise capable of preventing fluids from penetrating the protector film 120. In this manner, the protector film 120 can be used as a suitable protection against spills that may occur on the work surface 100. The protector film 120 can also be scratch and/or impact resistant. That is, the protector film 120 can be resistant to cracks, fractures, abrasions, scratches, or other undesirable deformities as a result of contact or impact from objects placed and/or dropped upon the surface.

Depending on the use, the protector film 120 can vary in thickness. Thicker protector films can provide more durability, but may negatively affect the touch sensitivity of the underlying touch operated equipment. Conversely, a thinner protector film 120 can provide greater touch sensitivity, but may offer less durability, and may be more difficult to apply, as the thinner materials may fold, warp, or wrinkle. In certain embodiments, the protector film 120 can be about 30 mils thick, which can be a thickness that provides suitable durability, while also maintaining high levels of touch sensitivity.

The protector film 120 protects the underlying electronics from moisture, spills or impacts while allowing for finger touch cuing of electronic equipment that is embedded underneath. In some embodiments, it can be useful to ensure that the protector film 120 is relatively clean prior to installation, as debris that is between the protector film 120 and the electronic equipment can result in a reduced touch sensitivity, thereby resulting in a less effective work surface 100.

The protector film 120 can be made of a plastic and/or polyester material. In some embodiments, the protector film 120 can be made of a polycarbonate material. In some embodiments, the protector film 120 can be made of a polished, hard-coated polycarbonate material. For example, certain embodiments of the present technology may use Lexan® HP92WP, HP92-SBD, or HPXXS film, manufactured by General Electric as the protector film 120.

Specifications and property values of materials that make suitable protector films are described in the disclosures and depicted in the Figures of U.S. Provisional Patent Application Nos. 61/789,095, 61/810,556, 61/840,627, each of which are hereby incorporated by reference in their entireties. It has been surprisingly discovered that such films provide sufficient durability and resistance to tears, abrasions, and fluids, while also maintaining high levels of touch and tap sensitivity for equipment installed in a work surface 100.

In certain embodiments of the present technology, the protector film 120 can be replaceably attachable to a touch and tap-operable work surface. In this manner the protector film 120 can be replaceable and/or changeable on the work surface. This allows a user the ability to apply different protector films 120 on a work surface 100 to achieve different looks, or to replace protector films 120 when they become worn, damaged, or soiled. For example, in certain embodiments a user may wish to provide a work surface 100 (e.g., a countertop work surface at a restaurant) that depicts a seasonal scene, such as a holiday image in December, or a summertime image in June. In this manner, the user can apply a protector film 120 with a desired image or pattern printed upon it on the work surface 100. The user can then remove that protector film 120 when desired, and install a new protector film 120 with a different image or pattern printed upon it.

As noted, the protector film 120 can be provided over one or more input devices embedded in the substrate 110, such as a sensing pad (or touch pad), a tap/touch keypad or keyboard, a touch screen video monitor, an induction charger, or an NFC reader, for example.

In some embodiments, the input devices can be located under the protector film 120 and can be capable of controlling a display and/or a CPU. The protector film 120 can be configured so that the tap/touch functionality can work through the film in the same manner that the tap/touch functionality works through a glass surface; however, in certain embodiments, the protector film 120 can provide improved functionality to that of a glass surface.

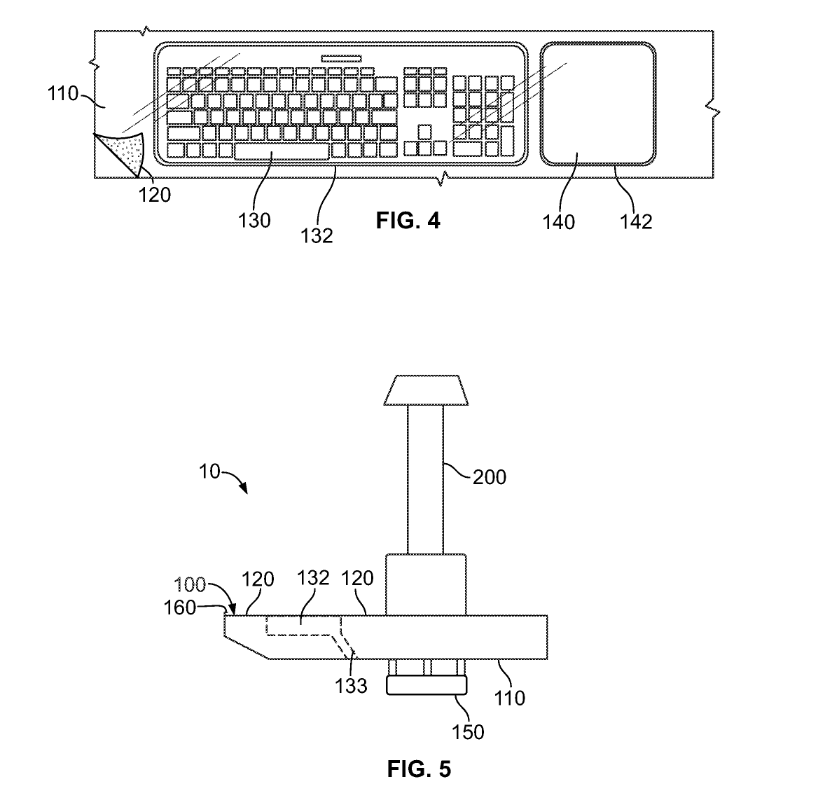

FIG. 4 provides an example of a work surface 100 using the protector film 120 of the present technology to cover and protect the input devices of the work surface 100. The work surface 100 comprises a substrate 110, which can be used as a structural base for the work surface 100, as described herein.

A keypad 130 (or keyboard), which can be, for example, a touch and/or a tap-operable keypad, is positioned on the substrate 110 within in a routed portion 132. In some embodiments, the routed portion 132 of the substrate is designed so that the upper surface of the keypad 130 is generally flush, level, or even with the upper surface of the substrate 110. The surfaces can be considered generally flush, generally level, or generally even when an adhesive material (e.g., a double-sided adhesive tape) and a protector film can be applied to the equipment and the substrate 110 without substantial air bubbles forming between them.

The keypad 130 can fit snugly within the routed portion 132, but it can also be slightly smaller than the routed portion, such that there is a nominal clearance between the edge of the keypad 130 and the edge of the routed portion 132 so that the keypad 130 can fit securely in the routed portion 132.

FIG. 5 is a side view of a work station 10 having a viewing area 200. FIG. 5 shows the depth of a routed portion 132 in the substrate 110 of a work surface 100. The routed portion 132 is of a depth so that a keypad or other input device can be placed therein and have an upper surface that is generally flush, even, or level with the upper surface of the substrate 110.

A hole 133 or channel can be drilled through the substrate 110 so that cables can be routed to various equipment of the work station, for example, to a CPU and/or a power source. In some embodiments, the hole 133 is sealed, for example, with a caulk or silicone, to inhibit heat from transferring to the protector film 120.

FIG. 5 also shows a cooling fan 150 mounted to the underside of the substrate, which can be used in some embodiments to keep the substrate 110 and the work surface 100 cool as the electronic equipment embedded within the substrate can generate significant heat in certain situations.

In some embodiments the work surface 100 can have an edge that covers the outer perimeter of the protector film 120. For example, as shown in FIG. 5, the edge of the work surface can include a rim 160, lip, or other covering that extends around the perimeter of the work surface 100, thereby overlying the outer portion of the protector film 120. In this manner, the rim 160 can provide an aesthetically pleasing finished look to the work surface 100, and can also inhibit and/or prevent the protector film 120 from readily peeling off of the work surface 100. In some embodiments, the rim 160 allows for the protector film 120 to expand and/or contract as a result of changes in temperature, or humidity, for example. That is, in some embodiments, the rim 160 does not contact and is not directly attached to the protector film. In this manner, the film can expand and restrict and/or retract without causing unnecessary tension or slack in the protector film.

In some embodiments, the rim 160 can be configured to form a water tight seal around the edge of the work surface 100. In this manner, fluids spilled on the work surface 100 may not be able to penetrate the work surface 100 and damage the underlying equipment. In some embodiments, the rim 160 can be sealed, for example, using a silicone or other flexible adhesive that allows the protector film 120 to expand and contract as described above.

The work surface 100 can be configured so that cables for the keypad 130 and all other equipment (e.g., power cables and connecting for the input devices, output devices, and CPU) pass through the underside of the work surface 100 via one or more holes in the substrate 110. The keypad 130 can be adhered to the routed portion 132 of the substrate 110, for example, with an epoxy, glue, or other adhesive.

In some embodiments, a portion of the protector film 120 that is adhered over the keypad 130 can have one or more textured surfaces to help a user distinguish and identify certain features of the keypad 130. For example, in some embodiments, each key of the keypad 130 can include bumps, ridges, outlines, indentations, milled out portions, raised portions, or sandblasted portions that help a user distinguish and identify the proper touch and/or tap location for each key. In some embodiments, only certain keys of the keypad 130 have textures or distinguishing portions. For example, in some embodiments, the “F” and “J” keys may have indentations or raised portions that help a user identify these keys on the keypad 130. In some embodiments, the keypad 130 comprises a numeric keypad, and the “5” key can include a texture or other distinguishing portion.

In some embodiments, the keypad 130 is a touch keypad that is sensitive to the capacitive touch of a user. In this manner, the touch keypad can comprise multiple touch capacitive sensors (e.g., one per key), each sensor generating a signal whenever the keypad detects a user touch. The user touch can be detected through the protector film 120 and any adhesive material that adheres the protector film to the keypad 130.

In some embodiments, the keypad 130 is a tap keypad that responds to physical tapping of a user. In this manner, the tap keypad may not generate a signal by the mere touch of a finger. That is, as a user places their fingers on the keys, the tap keypad does not process or issue a keystroke. Thus, a user's fingers may be able to rest on a typing home row, for example, without generating undesired keystrokes. In some embodiments, the tap keypad does not issue a keystroke until a vibration or other physical response is detected as a response to the force generated by a user tap.

In some embodiments, the keypad 130 can be a touch and tap sensitive keypad that is capable of operating as both a touch keypad and a tap keypad, as described herein. In some embodiments, the work surface 100 of the present technology can employ a touch and tap-sensitive keypad surface as disclosed and described in U.S. Pat. No. 8,325,141, titled “Cleanable Touch and Tap-Sensitive Surface,” which is hereby incorporated by reference in its entirety.

In some embodiments, the keypad 130 can be a common keyboard embedded into the substrate. In this manner, each key of the keyboard can be spring-loaded so that the key depresses upon the touch of a user. The keyboard can be, for example, a waterproof keyboard that is integrated into the work surface 100 such that an upper surface of the tap keyboard is generally flush or level with the upper surface of the substrate 110, but with depressible keys rising above the upper surface so that they can be pressed by a user.

As shown in FIG. 4, the work surface 100 can also comprises a sensing pad 140 embedded in a routed portion 142 of the substrate 110. The sensing pad 140 can operate, for example, as a touch mouse pad. That is, the sensing pad 140 can be configured to sense and track the motion of a user's finger along the sensing pad 140.

In some embodiments, the sensing pad 140 can be configured to detect user taps, or other functionality that may correspond to mouse “clicks.” For example, the sensing pad 140 can be configured to detect taps or double-taps and execute functionality that would correspond to a mouse click, or a mouse double-click accordingly. In some embodiments, the sensing pad 140 can also comprise a scrolling portion, or a button portion on various locations of the sensing pad 140.

In certain embodiments, the routed portion 142 is configured to be slightly larger than the sensing pad 140. In this manner, there can be a clearance or tolerance around the edge of the sensing pad 140. This clearance can assist in detecting taps or clicks on the sensing pad 140. That is, in some embodiments, a tap or click may requires a slight dynamic movement of the sensing pad 140, therefore, a minimum clearance may be useful to accommodate such movement. In this manner, the sensing pad 140 may not be directly adhered or secured to the substrate 110. In some embodiments, the sensing pad 140 can be centered within the routing portion 142, with a clearance of about 1/16″ of an inch between each edges of the sensing pad 140 and the edges of the routed portion 142.

In some embodiments, the keypad 130, the sensing pad 140, and other touch and/or tap functional components of the work surface 100 can be bonded to, or be a part of the protector film 120. For example, in some embodiments, the keypad 130 and/or sensing pad 140 can be a very thin material (e.g., about 1/16″) and bonded to the underside of the protector film 120. In this manner, the touch and/or tap operable equipment can be installed to the work surface 100 at the time that the protector film 120 is applied. That is, the touch/tap operated equipment may itself be a thin material that can be bonded to the lower surface of the protector film 120 and rolled onto the work surface 100 so that the equipment need not be embedded in routed portions of the substrate 110.

The protector film 120 covers the keypad 130 and sensing pad 140 and is secured with an adhesive material. In some embodiments, for example, the adhesive can be a double-sided adhesive tape. For example, during manufacturing, after the input devices and other functional equipment (e.g., the touch keypad, tap keyboard, sensing pad, induction charger, NFC reader, etc.) are installed in the substrate, a double-sided adhesive tape can be placed over the devices and the substrate, to provide an adhesive layer that can attach to the protector film 120. In some embodiments, the adhesive material can be glue, an epoxy, a spray, or another material that adheres the protector film 120 to the substrate 110 and the other underlying equipment of the work surface 100.

It has been surprisingly discovered that using double-sided adhesive tape is an effective technique for applying the protector film 120 to the work surface 100. Using double-sided tape can provide a smooth surface that the protector film 120 can be applied to. For example, double-sided adhesive tape, can create a smooth surface so that air bubbles or air pockets forming between the protector film 120 and the underlying equipment can be reduced, limited, prevented, minimized, and/or eliminated. Because air bubbles and air pockets can result in a reduced touch and/or tap sensitivity of the work surface 100 when the protector film 120 is applied, minimizing the number of air bubbles and air pockets between the surfaces can lead to improved work surface operation.

Double-sided adhesive tape can also help create an even adhesion surface. The even surface can facilitate the installation of the protector film 120, and allow the protector film 120 to be applied to the work surface 100 without forming a significant amount of air pockets between the protector film 120 and the underlying substrate 110 and equipment.

The adhesive strength of the double-sided tape can be sufficient to hold the protector film 120 in place on the work surface 100 under normal working conditions. In some embodiments, it may be desirable to use a tape with an adhesive strength sufficient to hold the protector film 120 in place permanently. Alternatively, in some embodiments, it can be desirable for the protector film 120 to be removable. In these embodiments it may be desirable to apply a tape that allows for the protector film 120 to be removed and reapplied. Accordingly, a double-sided adhesive tape having a low or medium tack adhesive on one side, and a high tack, or permanent adhesive on the other side can be suitable for application in a work surface of the present technology. In this manner, the protector film 120 could be removed from the work surface 100 without causing a delamination of the double-sided tape, and/or without leaving behind adhesive residue on the protector film 120.

In certain embodiments, the double-sided tape can be reused numerous times. That is, the protector film 120 can be removed and replaced one or more times without having to replace the double-sided adhesive tape.

In some embodiments, the double-sided tape can provide heat-resistive qualities. For example, in some embodiments, the double-sided adhesive tape can reduce the amount of heat that is transferred from the substrate and the electronic equipment to the protector film 120. In this manner, the double-sided adhesive tape can help limit or prevent the protector film 120 from expanding and/or bubbling as a result of heat effects.

In some embodiments, the thickness and material of the tape is selected to maintain high touch and/or tap sensitivity of the work surface 100. An example of a double-sided tape that can be effectively employed in certain embodiments of the present technology is 3M™ Repositionable Tape 9425, manufactured by the 3M™ Company.

It has been surprisingly discovered that the 3M™ Repositionable Tape 9425 product provides sufficient adhesive properties, while also allowing the input devices installed in the work surface 100 to maintain relatively high levels of touch and tap sensitivity. While it is described that the 3M™ Repositionable Tape 9425 is suitable for application in the present technology, it is appreciated that other tapes and adhesive techniques can also be used in the present technology, provided that the tape is able to achieve the adhesive and conductive results necessary for application. For example, the adhesive material can be glue, cement, a spray adhesive, or another adhesive material and/or technique that allows the protector film 120 to adhere to the substrate 110 and the other underlying equipment of the work surface 100 without substantial formation of air bubbles or air pockets.

The adhesive material can be configured so that the touch and/or tap operated input equipment (e.g., touch keypads and sensing pads) are able to sense and detect a user's touch through the adhesive material and the protector film 120. Moreover, the adhesive material can also be configured to allow the transmission of an electrical charge from an induction charger to a mobile device resting upon the work surface 100.

The adhesive material can be configured to cover some or all of the substrate, and all or some of the electronic devices embedded therein. For example, in some embodiments, the adhesive material can be applied to the entire surface of an input device, such as a touch and/or tap keypad, to ensure that the keypad retains a maximal and/or sufficient touch sensitivity when the protector film 120 is applied.

In some embodiments, the adhesive material can be applied to only a portion of an input device. For example, a sensing pad that is capable of depressing in response to a user “click,” may not operate effectively if the adhesive material is applied to the entire surface of the sensing pad. In some embodiments, therefore, it can be more effective to apply the adhesive material only to an internal portion of the sensing pad 140, leaving the edges of the sensing pad 140 and the portion of the substrate surrounding the sensing pad 140 un-taped. In this manner, the sensing pad 140 will be able to move, bend, and/or flex when pressed by a user, thereby retaining the ability to detect a user tap or click.

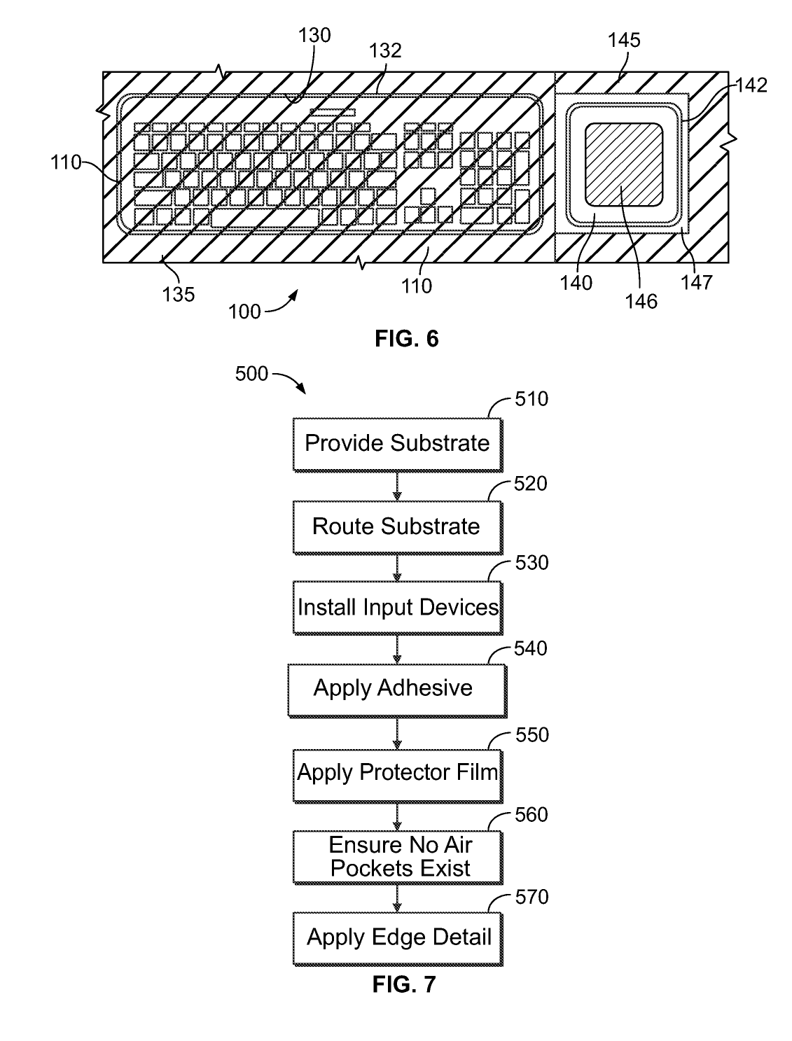

FIG. 6 shows an example of an adhesive material application pattern (e.g., a double-sided adhesive tape pattern) as it is applied to a work surface in accordance with at least one embodiment of the present technology. As shown, a keypad 130 is embedded in a routed portion 132 of the substrate 110 of a work surface 100. A sensing pad 140 is also embedded in a routed portion 142 of the substrate 110 such that there is a clearance between the edge of the sensing pad 140 and the edge of the routed portion 142.

The portions of the work surface 100 covered by the adhesive material are depicted with a cross-hatch pattern. As shown with taped portions 135 and 145, the entire keypad 130 is covered by adhesive material, as is the majority of the substrate 110. The sensing pad 140, however, is not entirely covered by the adhesive material. Rather, only the inner portion 146 of the sensing pad 140 is covered with adhesive material. An un-adhered portion 147 leaves the edge of the sensing pad 140 and a portion of the substrate 110 unattached to the protector film. In this manner, the sensing pad 140 can flex and/or move to allow for tap and/or click functionality. The size of the un-adhered portion 147 can vary depending on the size and function of the sensing pad. In certain embodiments, for example, the sensing pad 140 should be centered in the routed portion 142, and the un-tapped portion may extend ¾″ on each side of the sensing pad 140.

The present technology provides a work surface that can be used to control or operate a computer processor. In some embodiments, the work surface integrates a combination of multiple components, each component providing various function and utility. For example, the work surface can include or be configured to connect and operate with one or more computer systems.

The computer system can be operated and/or controlled via the touch and/or tap functionality of the work surface. This work surface can therefore provide a working surface that is relatively free, or even entirely free of computer equipment, such as a separate keyboard, mouse and monitor. The work surface is also configured so that the wires and interconnections between the work surface equipment are located within, not on the work surface.

In certain embodiments, the work surface and/or the computer system can include software that allows a user to connect to a roaming profile, such as a cloud computing account, or another user account accessible via a network or the internet, for example. The roaming profile can allow a user to access the information, software, and other resources from any work surface. For example, a user may be working on a certain project at the user's individual office work surface. That project may involve the use of various files and software packages. The user can upload the current project, along with the software, files and work surface status to the user's roaming profile so that the user can access that project, including the work surface status, files and software packages from another work surface.

In some embodiments, the present technology can enable a user to access a roaming profile from another work surface in the user's office building (e.g., a work surface in a conference room), a work surface at the user's home, or a work surface at a restaurant, café or coffee shop. This can provide a user with freedom to continue working on a project from any work surface, no matter the location, without the need to carry around a laptop computer or other equipment

The computer system and/or the work surface can be configured to have bluetooth functionality, such that a mobile device with bluetooth functionality can communicate with the computer system and/or the work surface. In certain embodiments, the present technology use near field communication. That is, the present technology may be capable of logging a user into the work surface, the CPU or another network by swiping, scanning and/or reading a mobile device, such as a cell phone, for example.

In some embodiments, the work surface of the present technology can comprise a viewing area 200, as shown in FIGS. 1-3. The viewing area 200 can comprise one or more monitors or viewing stations 210. In some embodiments, as shown in FIGS. 1-3, the viewing area 200 projects upwards from, and perpendicular to the work surface 100. In other embodiments, the viewing area 200 can include a surface display monitor embedded in the work surface 100 to provide a visual output of a computer to a user through the work surface. The viewing area 200 can be covered by the protector film 120, for example. In some aspects, the viewing area 200 can be configured to utilize touch and/or tap technology, so that a user can interact and operate the computer system through the viewing area 200.

In certain embodiments, the viewing area 200 can comprise two, three, four or more monitors or viewing stations 210. Various embodiments and configurations of work surfaces employing viewing areas suitable for use with the present technology are described in the disclosures and depicted in the Figures of U.S. Provisional Patent Application Nos. 61/759,729, 61/789,095, 61/810,556, 61/840,627, and U.S. Design patent application Nos. 29/459,379, 29/459,386.

Certain embodiments of the present technology include methods for manufacturing a work surface that is configured to provide user interaction with a computer. FIG. 7 provides a flow diagram a method 500 for making a work surface in accordance with at least one embodiment of the present technology.

At step 510, the method 500 involves providing a substrate to serve as a structural support for the work surface. For example, the substrate can be a board, plank, or platform suitable for holding and supporting computers and/or computer equipment. In some embodiments, for example, the substrate can be made of a laminated wood material, such as a pressed wood.

At step 520, the substrate is routed to accommodate the computer equipment. In step 520 the substrate can be routed to accommodate a keypad, a sensing pad, and an induction charger, for example. The substrate can be routed such that the upper surface of the equipment is designed to lie generally flush, level, or even with the upper surface of the substrate. The routing step 520 can also include routing or drilling holes to accommodate cables used to connect or provide power to the equipment. For example, the routing step can include drilling a hole in one or more of the routed portions designed to accommodate a keypad, thereby allowing the power and connector cables for the keypad to be arranged under the work surface. In some embodiments, the routing step 520 can include sealing the holes after the cables have been routed therethrough. For example, the routing step 520 can include sealing the holes with a silicone or caulk to insulate and seal the holes.

At step 530, input devices are installed in the substrate. The input devices can include a touch keypad, a tap keypad or keyboard, and/or a sensing pad, for example. In some embodiments, step 530 can also include installing other equipment such as an induction charger, an NFC reader, and/or viewing monitors. At step 530, some equipment can be adhered to the substrate. For example, in some embodiments, a touch or tap keypad can be adhered to the substrate within a routed portion with an epoxy. Certain equipment, however, such as a sensing pad, may not be directly adhered or attached to the substrate in any way.

At step 540, adhesive material is applied to the upper surfaces of the substrate and the installed equipment. For example, the adhesive material can be applied to all or a portion of the upper surfaces of the substrate and equipment, exposing a tacky upper surface of the adhesive material. Certain equipment, for example, a tap keypad, may be entirely covered with the adhesive material. However, in certain aspects, some equipment, such as a sensing pad, may be only partially covered with the adhesive material so that the equipment is free to move and/or flex slightly. In some embodiments, the adhesive material can be a double-sided adhesive tape.

At step 550, a protector film is applied to the work surface. The protector film can be pressed and applied to the exposed tacky surface of an adhesive material, for example, a double-sided tape, placed on the substrate. In this manner the protector film can be adhered to the work surface. In some embodiments, step 550 further includes cleaning the protector film, or ensuring that the film is otherwise free of dirt or other debris that can result in the formation of air pockets once installed on the work surface. In some embodiments, the protector film is applied in a manner that allows the film to be removed and/or replaced. For example, the adhesive material may have an adhesive property that allows the protector film to be peeled away and replaced with another protector film.

In some embodiments at step 550, the protector film is applied in a manner that minimizes or eliminates the amount of air pockets or air bubbles between the protector film and the adhesive material, the substrate, and/or the underlying equipment. In some embodiments, the method 500 further includes step 560, which ensures that no air pockets exist. Step 560 can include pressing or rolling the protector film to the work surface to press out any air pockets, for example.

In some embodiments, the method 500 can further include step 570 of applying edge detail to the work surface. For example, the method 500 can include the step of applying a rim or a lip around the edge of the work surface so that the protector film is inhibited from unwanted peeling off the work surface. In some embodiments, step 570 can comprise applying the edge detail in a manner that allows the protector film to freely expand and/or contract as necessary to accommodate a change in conditions, such as temperature or humidity. In some embodiments, step 570 can comprise sealing the perimeter of the work surface and the edge with a waterproof sealant to inhibit and/or prevent fluids from seeping below the protector film. In certain embodiments, the sealing can be performed in a manner that still allows the protector film to expand or contract, as described above.

In use, the present technology provides a work surface that can be easily cleaned and maintained. In this manner, keyboards and mouse setups can be kept clean and sterile without significant maintenance. That is, the present technology can be cleaned simply by spraying and wiping, as with a standard kitchen countertop.

The present technology can also provide anti-theft benefits. For example, the present technology can be equipped with anti-theft technology in the work surface.

The present technology can be used in connection with a wide variety of software and/or hardware setups. For example, the present technology can be used to connect users to a PC or a mac computer station.

The present technology also provides benefits in the realm of branding. Because the protector film of the present technology can be easily and efficiently printed upon, the present technology allows users to print brand names, logos, advertisements, or other descriptions. This can provide valuable branding when applied on work stations in public or corporate environments. Moreover, because the protector film can be readily removed and replaced, the present technology allows for fast and easy revisions to branding campaigns.

The present technology can provide convenient, efficient access to the internet or the cloud without requiring use of a personal device, such as a laptop computer, or personal mobile device. Moreover, the technology can also be provided in a manner that allows fast and efficient changes of the underlying CPU or other technology. In this manner, the work surfaces of the present technology can be revised to include state of the art computers and other equipment as technology advances.

The present technology has now been described in such full, clear, concise and exact terms as to enable any person skilled in the art to which it pertains, to practice the same. It is to be understood that the foregoing describes preferred embodiments and examples of the present technology and that modifications may be made therein without departing from the spirit or scope of the invention as set forth in the claims. Moreover, it is also understood that the embodiments shown in the drawings, if any, and as described above are merely for illustrative purposes and not intended to limit the scope of the invention. As used in this description, the singular forms “a,” “an,” and “the” include plural reference such as “more than one” unless the context clearly dictates otherwise. Further, all references cited herein are incorporated in their entirety.

1. A work surface configured to provide user interaction with a computer, the work surface comprising:
a substrate providing a structural base for the work surface, the substrate having an upper surface;
at least one input device installed on the substrate, each input device being operable to receive input from a user and to generate a signal based on the detection of the user input;
a protector film covering at least one input device; and
an adhesive material adhering the protector film to at least one input device and the substrate;
wherein the input device is configured to detect at least one of a user touch and a user tap through the protector film and the adhesive material.

2. The work surface of claim 1, wherein the at least one input device includes a sensing pad operable to detect a user touch, and operable to track the motion of a user's finger along the sensing pad.

3. The work surface of claim 2, wherein the adhesive material covers only a portion of the sensing pad.

4. The work surface of claim 3, wherein the sensing pad is configured to generate a click when tapped or pressed by a user.

5. The work surface of claim 1, wherein the at least one input device includes a keypad having a plurality of tap keys, each tap key configured to generate a signal when tapped by a user, and wherein each tap key is operable to detect a user tap through the protector film and the adhesive material.

6. The work surface of claim 5, wherein the keypad is configured so that each tap key only generates a signal when the key detects a tap having a sufficient force.

7. The work surface of claim 5, wherein the adhesive material covers the entire keypad.

8. The work surface of claim 7, wherein the protector film is connected to the keypad such that there are no air bubbles between the protector film and the keypad.

9. The work surface of claim 1, wherein the at least one input device includes a waterproof keyboard comprising a plurality of keys, each of the keys extending above the upper surface of the substrate and being configured to depress and to generate signal when pressed by a user.

10. The work surface of claim 1, wherein the at least one input device comprises:
a sensing pad operable to track the motion of a user's finger along the sensing pad, the sensing pad having an upper surface; and
a keypad having a plurality of tap keys, each tap key configured to generate a signal when tapped by a user, the keypad having an upper surface;
wherein the substrate comprises a first routed portion configured to receive the sensing pad, and a second routed portion configured to receive the keypad, and
wherein the sensing pad is installed in the first routed portion of the substrate and the keypad is installed in the second routed portion of the substrate such that the upper surface of the sensing pad and the upper surface of the keypad is generally level with the upper surface of the substrate when the sensing pad and keypad are installed in the substrate.

11. The work surface of claim 10, wherein the keypad is adhered to the substrate with an epoxy adhesive.

12. The work surface of claim 10, wherein the sensing pad is centered within the first routed portion of the substrate.

13. The work surface of claim 12, wherein the first routed portion is configured to receive a sensing pad so that there is a minimum clearance around each edge of the sensing pad.

14. The work surface of claim 13, wherein the minimum clearance is about 1/16″.

15. The work surface of claim 1, wherein the protector film comprises at least one textured portion to assist a user in distinguishing portions of the work surface.

16. The work surface of claim 15, wherein each textured portion corresponds to the installed location of at least one input device.

17. The work surface of claim 15, wherein each textured portion comprises at least one of a sand-blasted area, bumps, ridges, raised portions, indentations, and milled-out sections.

18. The work surface of claim 1, wherein the protector film is printable.

19. The work surface of claim 1, wherein the protector film is waterproof and protects electronic equipment installed beneath the protector surface from fluids and moisture.

20. The work surface of claim 1, wherein the protector film is replaceable on the work surface.

21. The work surface of claim 1, wherein the protector film has a thickness of about 30 mils.

22. The work surface of claim 1, further comprising an induction charger embedded in the substrate, the induction charger being covered by the protector film.

23. The work surface of claim 1, further comprising a near field communication reader embedded in the substrate, the near field communication reader being covered by the protector film.

24. The work surface of claim 1, further comprising at least one visual display area, the visual display area comprising at least one viewing monitor.

25. The work surface of claim 1, wherein the adhesive material is a double-sided adhesive tape.

26. A method of making a work surface, the work surface configured to provide user interaction with a computer, the method comprising the following steps:
providing a substrate as a structural support for the work surface;
generating at least one routed portion in the substrate, the routed portion configured to receive at least one input device;
installing at least one input device in a routed portion of the substrate;
applying an adhesive material to the substrate and the at least one input device;
applying a protector film over the substrate and the at least one input device by securing the protector film to the adhesive material; and
removing air pockets between the substrate or the input devices and the protector film.

27. A work surface configured to provide user interaction with a computer, the work surface comprising:
a substrate providing a structural base for the work surface, the substrate having an upper surface, the substrate further comprising a first routed portion and a second routed portion;
a sensing pad installed in the first routed portion of the substrate, the sensing pad operable to detect a user touch, and operable to track the motion of a user's finger along the sensing pad;
a keypad installed in the second routed portion of the substrate, the keypad having a plurality of tap keys, each tap key configured to generate a signal when tapped by a user;
a protector film covering the substrate, the sensing pad, and the keypad;
an adhesive material attaching the protector film to the substrate, the sensing pad and the keypad;
wherein the sensing pad is configured to detect a touch of a user through the protector film and the adhesive material,
wherein the keypad is configured so that each key is operable to detect a user tap through the protector film and the adhesive material, and
wherein the work surface is configured to communicate with at least one computer, the sensing pad and the keypad being operable to provide input to the computer.
